(19) United States
(12) Patent Application Publication
(10) Pub. No.: US 2008/0022254 A1
(43) Pub. Date: Jan. 24, 2008

(54) SYSTEM AND METHOD FOR IMPROVING MASK TAPE-OUT PROCESS

(75) Inventors: T. C. Luo, Hsinchu City (TW); Shien-Yang Wu, Jhudong Town (TW); H. C. Tseng, Hsinchu City (TW); Chia-Chiang Chen, Hsin-Chu (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD., Hsin-Chu (TW)

(21) Appl. No.: 11/697,800

(22) Filed: Apr. 9, 2007

Related U.S. Application Data
(60) Provisional application No. 60/807,912, filed on Jul. 20, 2006.

(51) Int. Cl. G06F 17/50

(52) U.S. Cl. 716/19

(57) ABSTRACT

An integrated circuit (IC) design system includes an IC design module for generating various portions of a mask layout according to a predefined specification of an integrated circuit, a mask module for assembling the various portions of the mask layout and forming a tape-out of the mask layout for mask manufacturing, and an e-LOP module operable to convert at least a subset of the various portions of the mask layout in a GDS format at a design stage prior to forming the tape-out.

### PRIORITY DATA

This application claims the priority under 35 U.S.C. §119 of U.S. Provisional Application Ser. No. 60/807,912 entitled “A SYSTEM AND METHOD FOR IMPROVING MASK TAPE-OUT PROCESS,” filed on Jul. 20, 2006.

### BACKGROUND

The present disclosure relates generally to semiconductor device manufacturing and, more particularly, to a photomask or mask tape-out process.

The entire disclosure of the following patent application is hereby incorporated herein by reference: US provisional patent application “DESIGN FOR MANUFACTURING” BY Ru-Gang Liu, et al. (attorney docket number 24061.783).

In semiconductor manufacture, there is no dry run system or simulation tool for the verification of test and circuit design structures (test line and customer's chip), logical operation (LOP) change, and optical proximity correction (OPC) process before mask tape-out. All this is important to ensure new tape-out first silicon success. Therefore, what is needed is a simple and cost-effective system and method for improving the mask tape-out process.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic diagram of an operating environment in which various aspects of the present disclosure may be performed therein.

FIG. 2 is a flow chart of a conventional method for a mask tape-out process.

FIG. 3 is a flow chart of a method for a mask tape-out process utilizing an e-LOP system according to one embodiment of the present disclosure.

FIG. 4 is a diagram illustrating an algorithm implemented by the e-LOP system of FIG. 3.

FIGS. 5 and 6 is a schematic view of examples implementing a test run of the e-LOP system of FIG. 3.

FIGS. 7 through 13 are window views of one embodiment of an operational flow of the e-LOP system of FIG. 3.

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

A system and method of the present disclosure generates a post-LOP GDS file which can be downloaded to a customer's local computer for verification (including test structures, circuit, and LOP change) with a generic layout viewer such as Laker, Virtuoso, or L-edit. By doing this, the customer is able to detect potential issues or problems (such as LOP change, test structure issue, circuit structure issue) at a very early stage of the design prior to tape-out. In addition, it can also link to an OPC process to check for any potential weak spots.

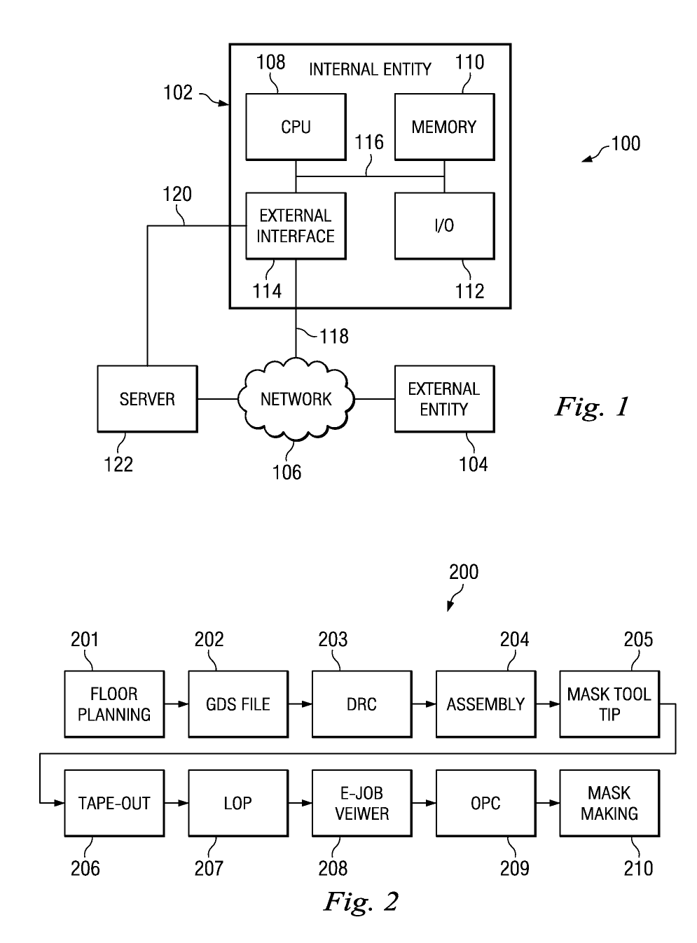

Referring to FIG. 1, illustrated is a system 100 within which a method (described in detail below) may be performed. The system 100 includes a plurality of entities, represented by one or more internal entities 102 and one or more external entities 104 that are connected by a communications network 106. The network 106 may be a single network or may be a variety of different networks, such as an intranet and the Internet, and may include both wireline and wireless communication channels.

The internal entities 102 represents those entities that are directly responsible for producing the end product, such as a wafer or individually tested IC devices. Examples of internal entities 102 include an engineer, customer service personnel, an automated system process, a design or fabrication facility and fab-related facilities such as raw-materials, shipping, assembly or test. Examples of external entities 104 include a customer, a design provider; and other facilities that are not directly associated or under the control of the fab. In addition, additional fabs and/or virtual fabs can be included with the internal or external entities. Each entity may interact with other entities and may provide services to and/or receive services from the other entities.

It is understood that the entities 102-104 may be concentrated at a single location or may be distributed, and that some entities may be incorporated into other entities. In addition, each entity 102, 104 may be associated with system identification information that allows access to information within the system to be controlled based upon authority levels associated with each entities identification information. The system 100 enables interaction among the entities 102-104 for purposes related to IC manufacturing, as well as the provision of services.

One or more of the services provided by the system 100 may enable collaboration and information access in such areas as design, engineering, and logistics. For example, in the design area, the customer 104 may be given access to information and tools related to the design of their product via the fab 102. The tools may enable the customer 104 to perform yield enhancement analyses, view layout information, and obtain similar information. In the engineering area, the engineer 102 may collaborate with other engineers 102 using fabrication information regarding pilot yield runs, risk analysis, quality, and reliability. The logistics area may provide the customer 104 with fabrication status, testing results, order handling, and shipping dates. It is understood that these areas are exemplary, and that more or less information may be made available via the system 100 as desired.

Another service provided by the system 100 may integrate systems between facilities, such as between a facility 104 and the fab facility 102. Such integration enables facilities to coordinate their activities. For example, integrating the design facility 104 and the fab facility 102 may enable design information to be incorporated more efficiently into the fabrication process, and may enable data from the fabrication process to be returned to the design facility 104 for evaluation and incorporation into later versions of an IC.

Referring now to FIG. 2, illustrated is a current tape-out flow process 200. A customer provides an integrated circuit (IC) for manufacture. The tape-out process 200 includes a floor planning process 201 in which the various structures making up the IC are provided in a design layout (or database). The process 200 includes generating an electronic file of the design layout in a GDS format 202. The design layout GDS file is checked by a design rule check (DRC) 203 tool to ensure the design layout complies with various design rules such as a minimum density rule. It is understood that other types of file formats may be also be used in this example. The process 200 continues with an assembly process 204. The circuit design may be partitioned into various blocks, each block performing a specific function. Accordingly, the various blocks are assembled together and the entire design layout (or database) is ready for photomask (or mask) processing.

The process 200 includes a mask tooling (MT) Tip process 205 where a number of mask images are generated based on the finished design layout. The number of mask images will vary depending on the complexity of the design layout. The process 200 is now in a tape-out stage 206 which represents when the design layout (or database) is ready for the chip manufacture. The process 200 includes a logical operation (LOP) process 207 performed on each of the mask images. The LOP may be provided by the chip manufacture and may be modified by the customer. After the LOP process 207, the mask images may be viewed and checked by the customer through a E-Job Viewer 208. After inspecting the mask images, an optical proximity correction (OPC) process 209 may be performed on the mask images to compensate for the non-ideal properties of photolithography. The process 200 ends with a mask making process 210 for each of mask images. It is understood that each of the processes described above may be implemented by physical hardware and/or programs and methods.

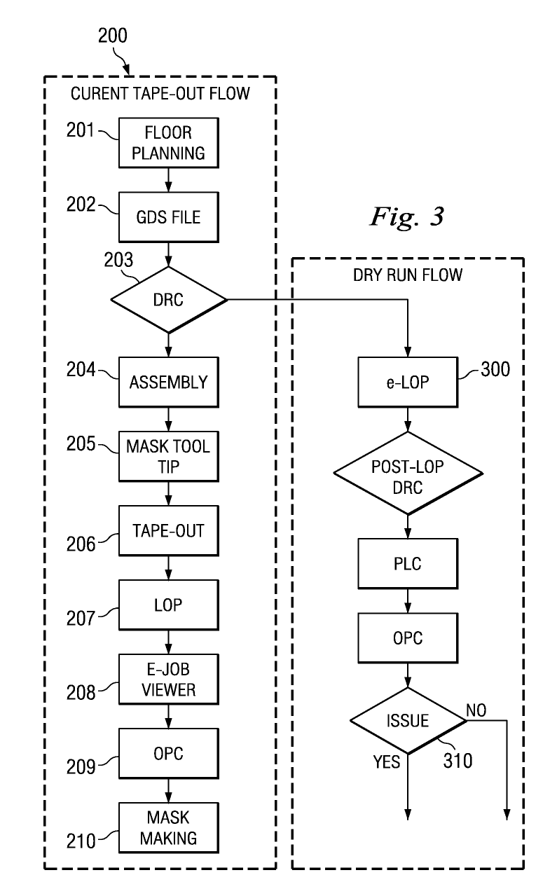

Referring now to FIGS. 3 through 6, illustrated is one embodiment of a method for improving the mask tape-out process 200 shown in FIG. 2. The method in FIG. 3 is similar to the method 200 of FIG. 3 except that an e-LOP system 300 may provide a dry run system or simulation tool for verifying test and circuit design structures (test line and customer's chip), logical operation (LOP) changes, and optical proximity correction (OPC) processing before mask tape-out. Similar features in FIGS. 2 and 3 are numbered the same for simplicity and clarity. In FIG. 3, The e-LOP system 300 is provided after the design layout (database) has been checked by the DRC. The e-LOP system 300 may alternatively be implemented after an electronic file of the design layout is generated in GDS format. The e-Lop system 300 receives a design layout in GDS format and generates a post-LOP GDS file which can be downloaded by the customer to his/her local computer for verification (including test structures, circuit structures, LOP change). The GDS file can be viewed with a generic layout viewer such as Laker, Virtuoso, L-edit. This will allow the customer to detect potential problems or issues 310 (such as LOP change, test structure issue) at a very early design stage ahead of real product tape-out. The e-Lop system 300 may be linked to a post-LOP design rule check (DRC) tool ensure the design layout complies with various design rules. Additionally, the e-LOP system 300 can also link to an OPC process to detect any potential weak spots.

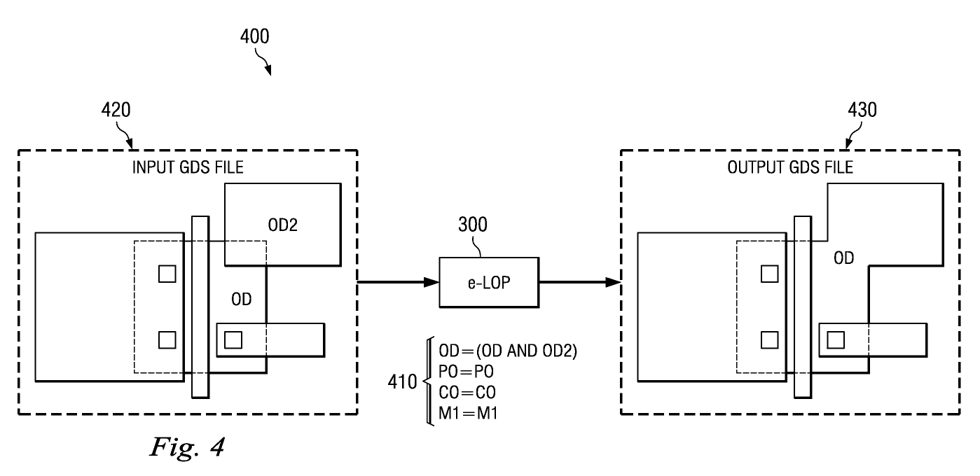

In FIG. 4, illustrated is one embodiment of an algorithm 400 implemented by the e-LOP system 300 of FIG. 3. The algorithm 400 is based on a set of logical operation (LOP) equations 410. The LOP equations 410 may be provided by the chip manufacturer and may be modified by the customer. An input GDS file 420 of the design layout (or database) is provided to the e-LOP system 300 as an input and is transformed based on the set of LOP equations 410. The e-LOP system 300 generates a post-LOP output GDS file 430. The output GDS file 430 may be viewed with a generic layout viewer such as Laker, Virtuoso, L-edit at the customer's location via the Internet or other type of communication network. This will allow the customer to detect potential problems or issues (such as LOP change, test structure issue) at a very early design stage ahead of real product tape-out.

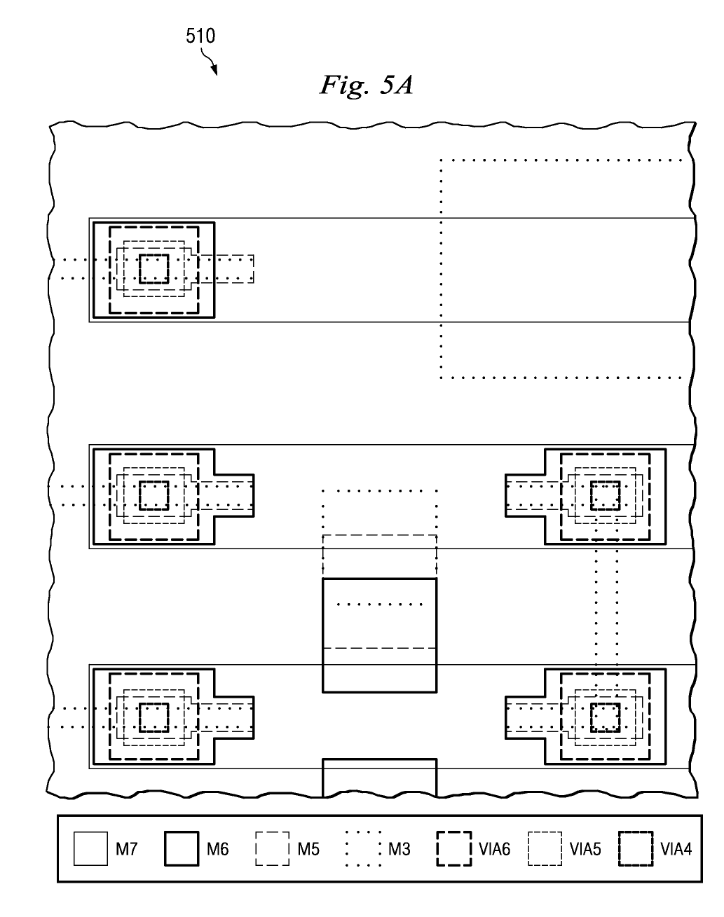

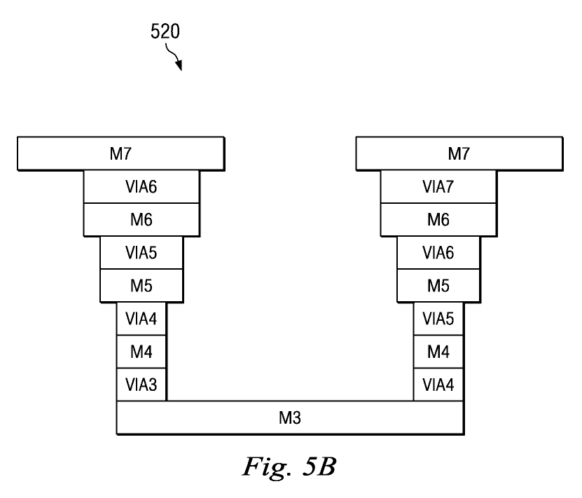

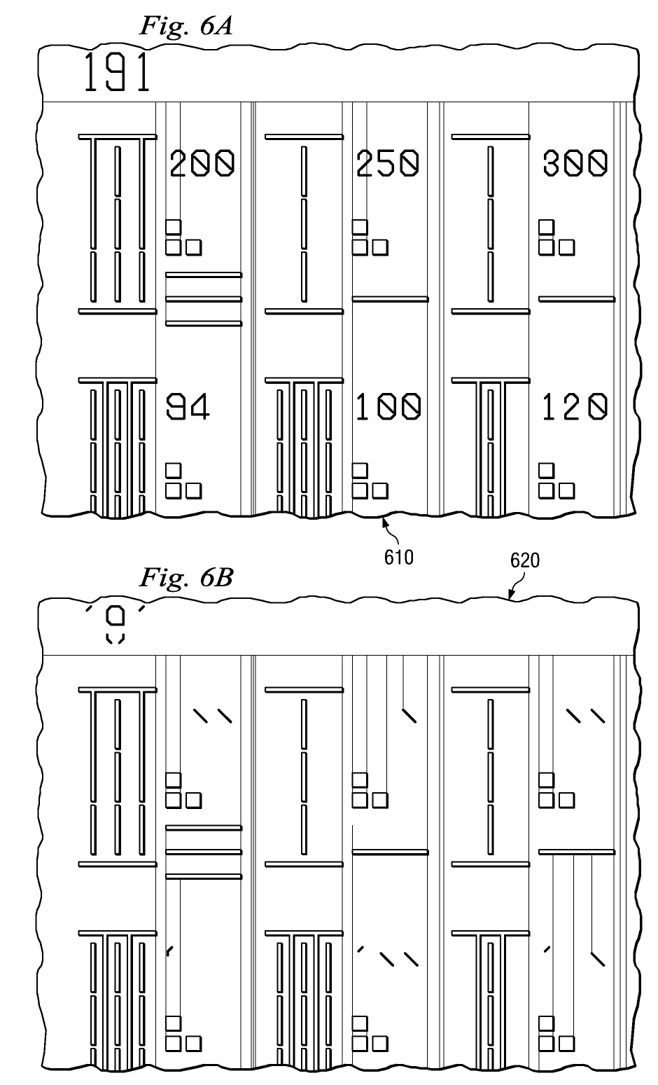

In FIGS. 5 and 6, illustrated are examples of a test run of the e-LOP system 300 of FIG. 3. FIG. 5 shows an example of a post-LOP output GDS file that is viewed by a generic viewer. In the present example, a 65 nm node (N-65) semiconductor device is shown including stack vias 3 through 6 (Via3-Via6) connecting metal layers 3 through 7 (M3-M7) in a layout view 510 and cross-sectional view 520. In FIG. 6, an example of a 55 nm node (N-55) logical operation valuation for mask tape-out is shown. In the present example, the e-LOP system shows verification of a LOP equation and design layout to determine a correct LOP 610 and incorrect LOP 620. The correct LOP 610 is: ((((((3;0 AND 50;0) SIZING 0.014) SIZING 0.17) SIZING −0.34) SIZING 0.17) OR 2;0); and the incorrect LOP 620 is: ((((((3;0 AND 50;0) SIZING 0.014) OR 2;0) SIZING 0.17) SIZING −0.34) SIZING 0.17). Accordingly, the e-LOP system may detect the LOP error before submitting the design layout to the mask tape-out process and thus, shorten the cycle time of a mask tooling process.

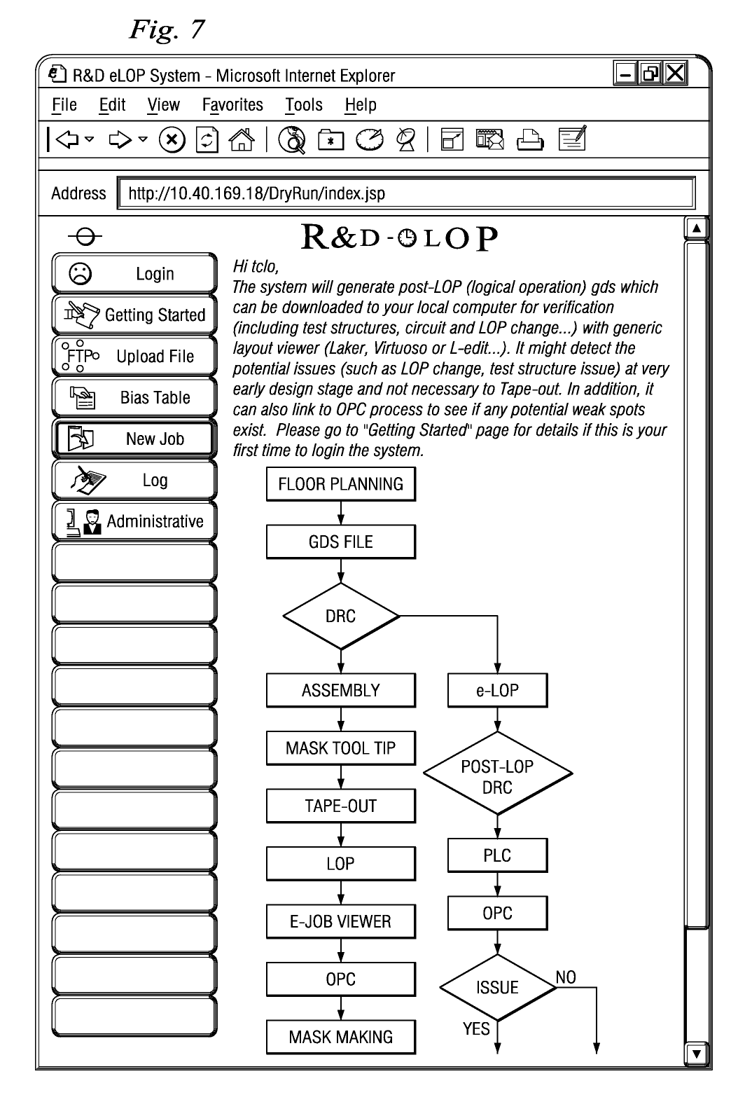

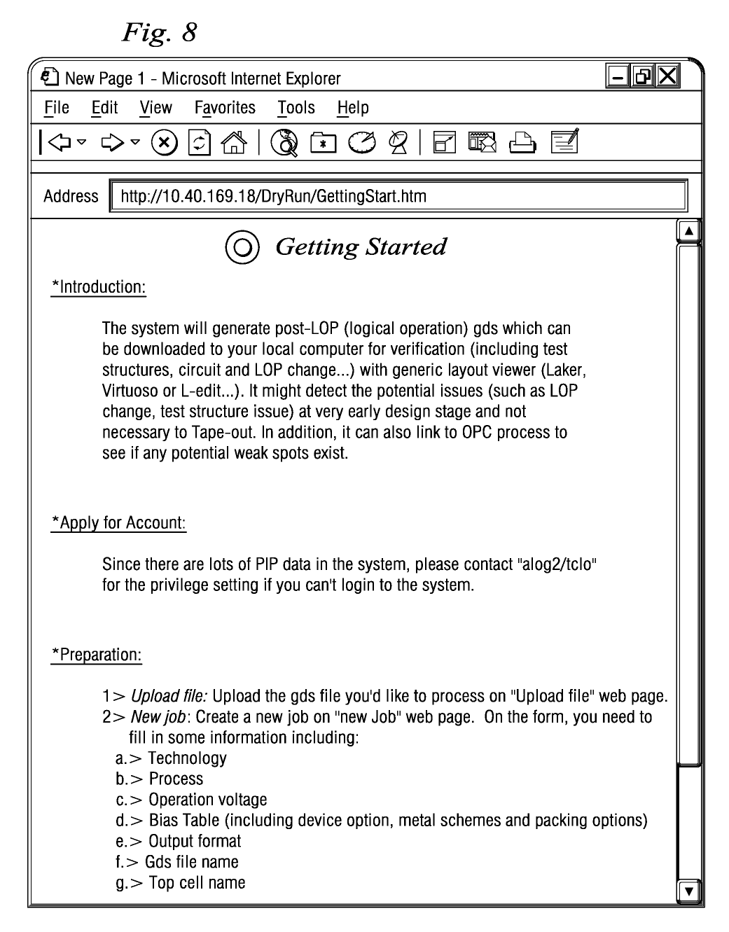

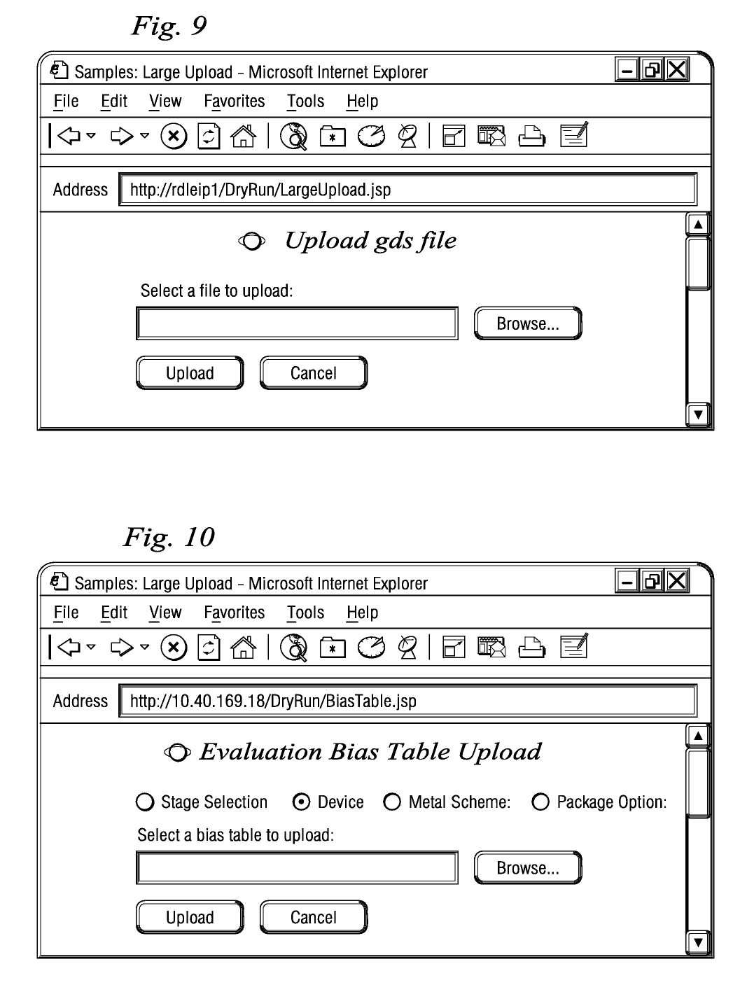

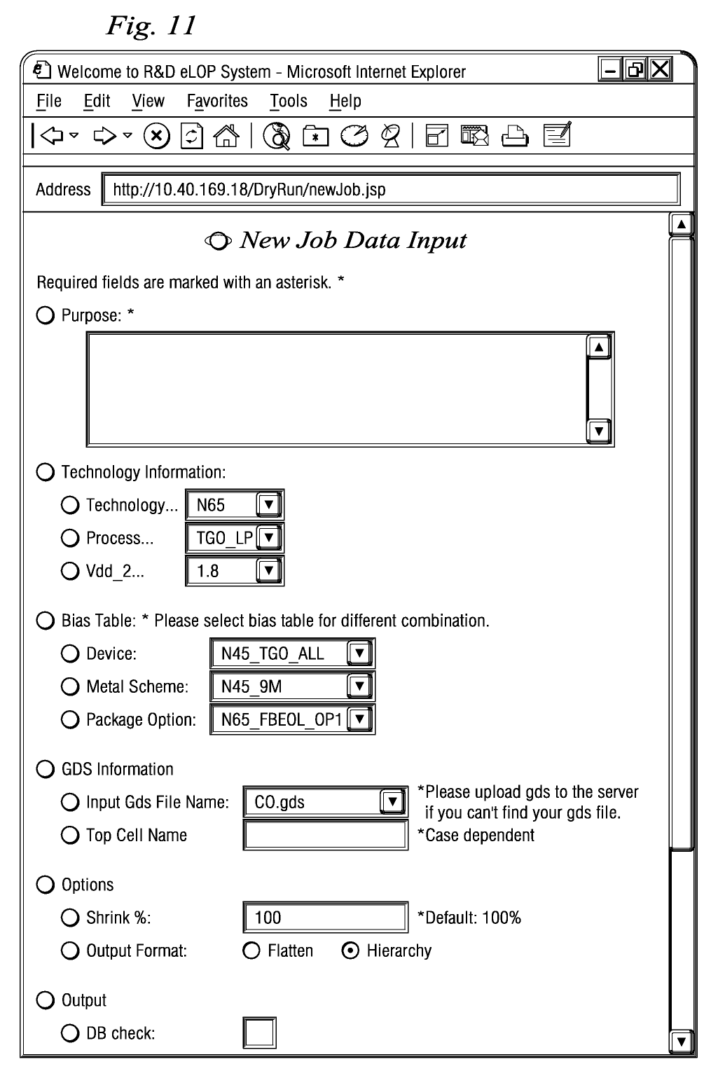

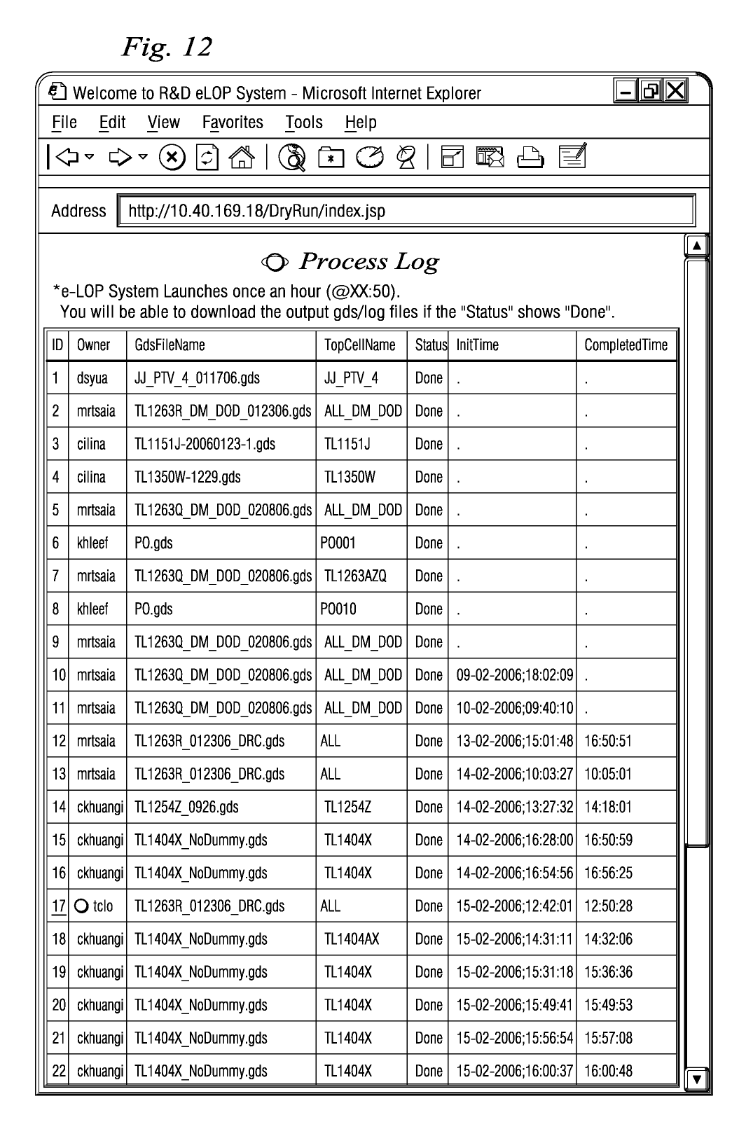

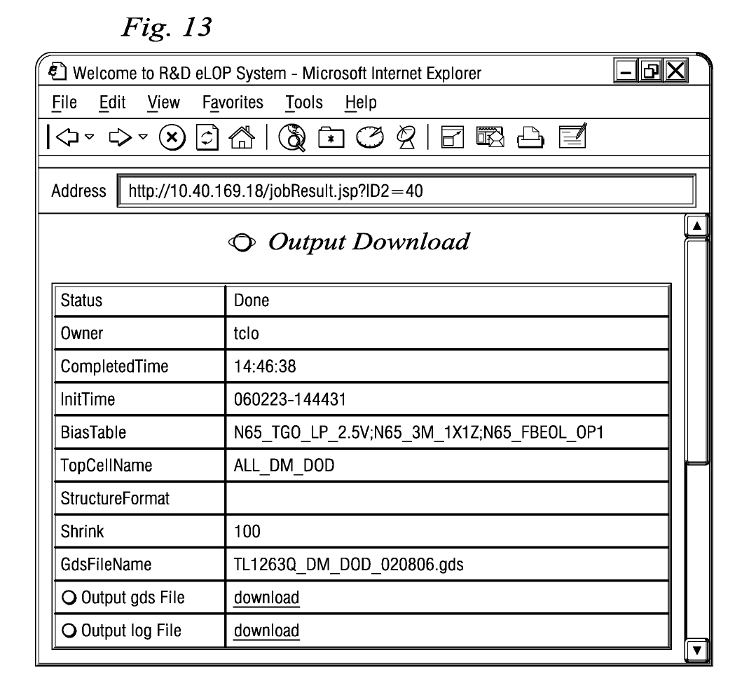

Referring now to FIGS. 7 through 13, illustrated are window views of one embodiment of an operation flow of the e-LOP system 300 of FIG. 3. As previously discussed, the e-LOP system may be accessed by a customer via the Internet or other communication network. In FIG. 7, the e-LOP system begins with a login page where the customer is verified for access to the e-LOP system. The customer may be asked for a user ID and password. After login, the customer is transferred to a getting started page as illustrated in FIG. 8. The getting started page explains the e-LOP system and gives the requirements for using the system. An input GDS file is uploaded as illustrated in FIG. 9. An evaluation bias table is then uploaded as illustrated in FIG. 10. The e-LOP system then ask for several parameters (e.g., new job data input) before running the LOP simulation as illustrated in FIG. 11. The e-LOP system generates a process log to indicate whether or not the LOP simulation has been completed as illustrated in FIG. 12. Illustrated in FIG. 13, the e-LOP system generates a post-LOP output GDS file so that the customer can download to their local computer and verify their test and circuit structures and LOP modification by directly viewing the mask design layout on a generic viewer. The customer does this before mask tape-out. The customer can view all the layers of the circuit design stacked together in the GDS file.

Some of the many advantages of the present disclosure are as follows: (1) Offers post-LOP (logical operation) GDS file with post-DRC and full layers stack for test structures design and LOP verification before or without tape-out. (2) Easy to use for verification and not necessary to tape-out with high performance as compared with current e-JobView system. (3) Compatible platform with current commercial electronic automation design (EDA) tool. (4) Implementation of verification flow to ensure the possibility of first silicon success and speed-up tape-out schedule. (5) Potential value added customer service with providing post-LOP output GDS file for design verification to speed-up chip verification. (6) Provide another fast e-JobView channel for design/LOP verification.

The e-LOP system allows a customer to verify his/her design layout way before tape-out. This would minimize the possibility of making mistakes especially for future technologies as designs become more complex and more layers are used. The e-LOP system also allows the customer to quickly verify and confirm their design layout because the system generates a post-LOP output GDS file which can be downloaded to their local computer and viewed by a generic layout viewer. This will provide better customer service and shorten the cycle time in the mask tooling process. The e-LOP system allows the customer to catch possible design layout problems and LOP errors before submitting the design layout to mask tooling. This will save the customer time and money. The e-LOP system allows a user to inspect multiple layers of the design layout together simultaneously to find errors according to their relative position instead of one layer at a time.

In summary, the aspects of the present disclosure provide a method and system for improving mask tape-out process. Problems associated with LOP can be detected early and the designer is able to review all structures on the mask before tape-out. In this way, process yields can be increased, cycle time for mask tooling can be shortened, cost of fabrication can be reduced and/or customer service satisfaction may be improved.

The present disclosure can take the form of an entirely hardware embodiment, an entirely software embodiment, or an embodiment containing both hardware and software elements. In an illustrative embodiment, the disclosure is implemented in software, which includes but is not limited to firmware, resident software, microcode, etc. Furthermore, embodiments of the present disclosure can take the form of a computer program product accessible from a tangible computer-usable or computer-readable medium providing program code for use by or in connection with a computer or any instruction execution system. For the purposes of this description, a tangible computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, a semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital video disc (DVD).

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. An integrated circuit (IC) design system, comprising:
an IC design module to generate various portions of a mask layout according to a predefined specification of an integrated circuit;
a mask module for assembling the various portions of the mask layout and forming a tape-out of the mask layout for mask manufacturing; and
an e-LOP module operable to convert at least a subset of the various portions of the mask layout in an electronic format at a design stage prior to forming the tape-out.

2. The IC design system of claim 1, wherein the design stage includes a design rule check (DRC).

3. The IC design system of claim 1, wherein the electronic format includes a GDS format.

4. The IC design system of claim 1, further comprising a viewing module for viewing the various portions of the mask layout after it has been converted by the e-LOP module.

5. The IC design system of claim 4, wherein the viewing module is accessed via an Internet.

6. A method of designing integrated circuit (IC) mask, comprising:
generating an integrated circuit in various portions of a mask layout according to a predefined specification of an integrated circuit;
integrating the various portions of the mask layout into a tape-out of the mask layout for mask manufacturing; and
converting a subset of the various portions of the mask layout into a set of mask data in a GDS format prior to integrating the various portions of the mask layout.

7. The method of claim 2, wherein the converting the subset of various portions of the mask layout comprises implementing various logical operations to the various portions of the mask layout.

8. The method of claim 2, wherein the set of mask data is viewable through a GDS viewing tools.

9. The method of claim 2, wherein the set of mask data is transferable through Internet.
